(19) United States
(12) Patent Application Publication
(10) Pub. No.: US 2011/0187485 A1
(43) Pub. Date: Aug. 4, 2011

(54) TRANSFORMER HAVING SECTIONED BOBBIN

(75) Inventors: Terumasa TOYODA, Tokyo (JP); Hiroshi MAEDA, Tokyo (JP); Toru HONMA, Tokyo (JP); Nobuo KITAJIMA, Tokyo (JP); Kazunori ISHIBASHI, Tokyo (JP)

(73) Assignee: TDK CORPORATION, Tokyo (JP)

(21) Appl. No.: 13/016,043

(22) Filed: Jan. 28, 2011

(30) Foreign Application Priority Data
Feb. 4, 2010 (JP) 2010-023347
Nov. 1, 2010 (JP) 2010-244935

(51) Int. Cl. H01F 27/29

(52) U.S. Cl. 336/192

(57) ABSTRACT

A transformer includes a bobbin, terminal electrodes, a core, a primary winding, a secondary winding, and an additional winding. The bobbin is made from an electrically insulating material and has a tubular portion defining an internal space. The tubular portion has an outer peripheral surface providing a first through third sections arrayed side by side in an axial direction of the tubular portion. The terminal electrodes are provided at the bobbin for electrical connection to the windings. The core is inserted into the internal space. The primary winding has an insulating layer and is wound over the first section. The secondary winding has an insulating layer and is wound over the third section. The additional winding is wound over the second section and has an insulation layer whose insulating performance is greater than that of the insulation layer of the primary winding and the secondary winding.

### CROSS REFERENCE TO RELATED APPLICATION

This application claims priorities from Japanese Patent Application Nos. 2010-023347 filed Feb. 4, 2010 and 2010-244935 filed Nov. 1, 2010. The entire content of each of these priority applications is incorporated herein by reference.

### TECHNICAL FIELD

The present invention relates to a transformer, and more particularly, to a type thereof having a tubular bobbin whose outer peripheral surface is divided into a plurality of sections arrayed in an axial direction of the bobbin, a primary wiring wound over one section, and a secondary wiring wound over a different section.

### BACKGROUND

A transformer used as a power source generally includes a bobbin and primary and secondary wirings wound over the bobbin. The bobbin is generally tubular shaped and a plurality of partition plates protrude outward from an outer peripheral surface of a body of the bobbin and are arrayed in an axial direction thereof so as to provide a plurality of sections. Primary and secondary windings are wound over respective sections, and are spaced away from each other in the axial direction by a thickness of the partition plate so as to meet with a safety standard. Such conventional transformer is described in Japanese utility model Application Publication No. H5-48313.

### SUMMARY

The present inventors have found that the conventional transformer has a limited enhancement of magnetic coupling between the primary and the secondary wirings due to the predetermined thickness of the partition plate, even though the partition wall having the predetermined thickness is required for the safety standard. Particularly, a demand of higher frequency is escalating recently in the performance of the transformer, and smaller leakage inductance is required to this effect. However, it would be difficult to reduce the leakage inductance by way of the enhancement of the magnetic coupling due to conflicting requirement in terms of safety standard.

Further, a demand of downsized and low profile transformer is increasing recently. However, downsizing of the bobbin leads to reduction in spaces for providing the primary and secondary windings, yet the partition wall having the predetermined thickness is still required. Consequently, it would be difficult to obtain sufficient space for the windings. In other words, the partition plate having the predetermined thickness poses an impediment against downsizing and low profile demand.

It is therefore, an object of the present invention to provide a downsized and low profile transformer providing enhanced magnetic coupling between primary and secondary windings yet meeting with safety standard.

This and other objects of the present invention will be attained by providing aA transformer including a bobbin, a plurality of terminal electrodes, a core, a primary winding, a secondary winding, and an additional winding. The bobbin is made from an electrically insulating material and has a tubular portion defining an axial direction and an internal space. The tubular portion has an outer peripheral surface providing a first section, a second section, and a third section arrayed side by side in the axial direction. The plurality of terminal electrodes are provided at the bobbin and includes a first terminal electrode, a second terminal electrode, a third terminal electrode, a fourth terminal electrode, a fifth terminal electrode, and a sixth terminal electrode. The core is inserted into the internal space. The primary winding of a conductive wire is coated with an insulating layer and is wound over the first section. The primary winding has one end portion electrically connected to the first terminal electrode and another end portion electrically connected to the second terminal electrode. The secondary winding of a conductive wire is coated with an insulating layer and is wound over the third section. the secondary winding has one end portion electrically connected to the third terminal electrode and another end portion electrically connected to the fourth terminal electrode. The additional winding of a conductive wire is coated with an insulation layer whose insulating performance is greater than that of the insulation layer of the primary winding and the secondary winding. The additional winding is wound over the second section, and the additional winding has one end portion electrically connected to the fifth terminal electrode and another end portion electrically connected to the sixth terminal electrode.

### BRIEF DESCRIPTION OF THE DRAWINGS

In the drawings:

FIG. 1 is a plan view of a transformer according to a first embodiment of the present invention;

FIG. 2 is a bottom view of the transformer and particularly showing a primary winding, a secondary winding, and a bobbin according to the first embodiment;

FIG. 3 is a plan view of a case of the transformer according to the first embodiment;

FIG. 4 is a plan view of a core of the transformer according to the first embodiment;

FIG. 5 is a circuit diagram of the transformer according to the first embodiment;

FIG. 6 is a plan view of a transformer according to a second embodiment of the present invention;

FIG. 7 is a bottom view of the transformer according to the second embodiment;

FIG. 8 is a cross-sectional view of the transformer taken along the line VIII-VIII of FIG. 7 according to the second embodiment;

FIG. 9 is a bottom view of the transformer and particularly showing a bobbin and windings wound over the bobbin according to the second embodiment; and,

FIG. 10 is a circuit diagram of the transformer according to the second embodiment.

### DETAILED DESCRIPTION

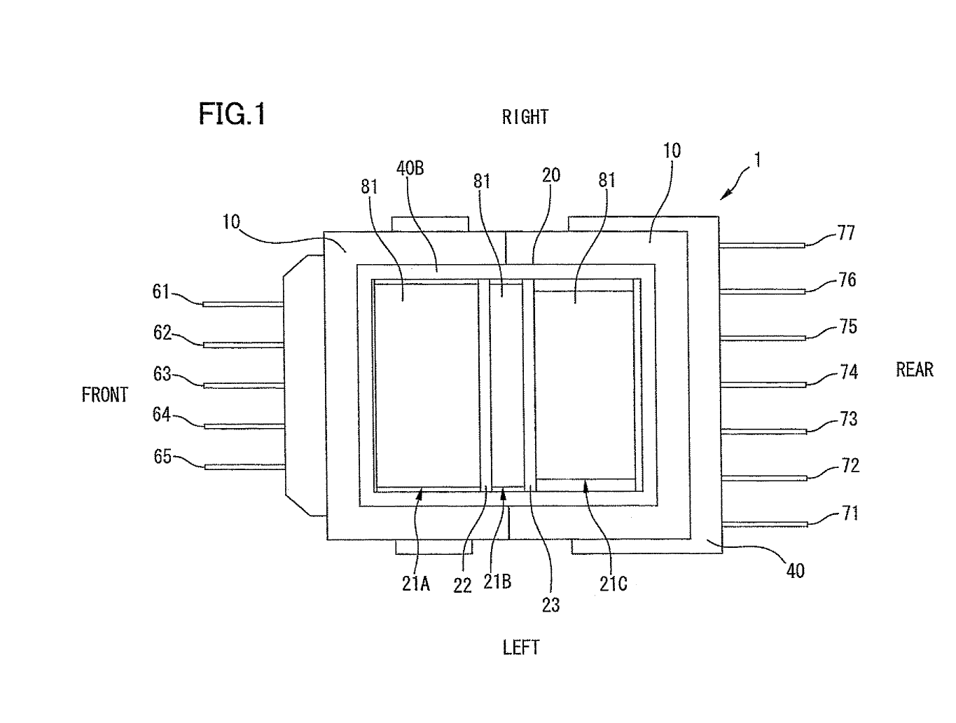

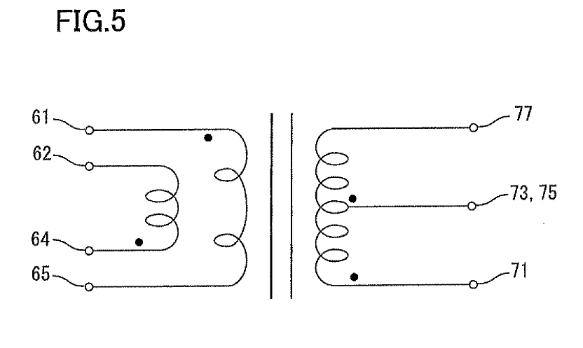

A transformer according to a first embodiment of the present invention will be described with reference to FIGS. 1 through 5. The transformer 1 includes a core 10, a bobbin 20, a case 40, and a conductive wire 50. With reference to the first embodiment, an upper side and a lower side in FIG. 1 will be referred to as “rightward” and “leftward”, respectively, and a left side and right side in FIG. 1 will be referred to as “frontward” and “rearward”, respectively.

As shown in FIG. 4, a pair of the cores 10 having a shape identical to each other are provided. Each core 10 is E-shaped and includes an end plate portion 10A, a pair of side plate portions 10B each extending from each end portion of the end plate portion 10A, and a central stem portion 10C extending from a longitudinally center portion of the end plate portion 10A. Free end faces of the side plate portions 10B of one of the cores 10 are in contact with free end faces of the side plate portions 10B of the remaining one of the cores 10, whereas a free end face of the central stem portion 10C of one of the cores 10 is spaced apart by a predetermined distance from a free end face of the central stem portion 10C of the remaining one of the cores 10. The side plate portions 10B correspond to a surrounding portion, and the central stem portion 10C corresponds to an insertion portion.

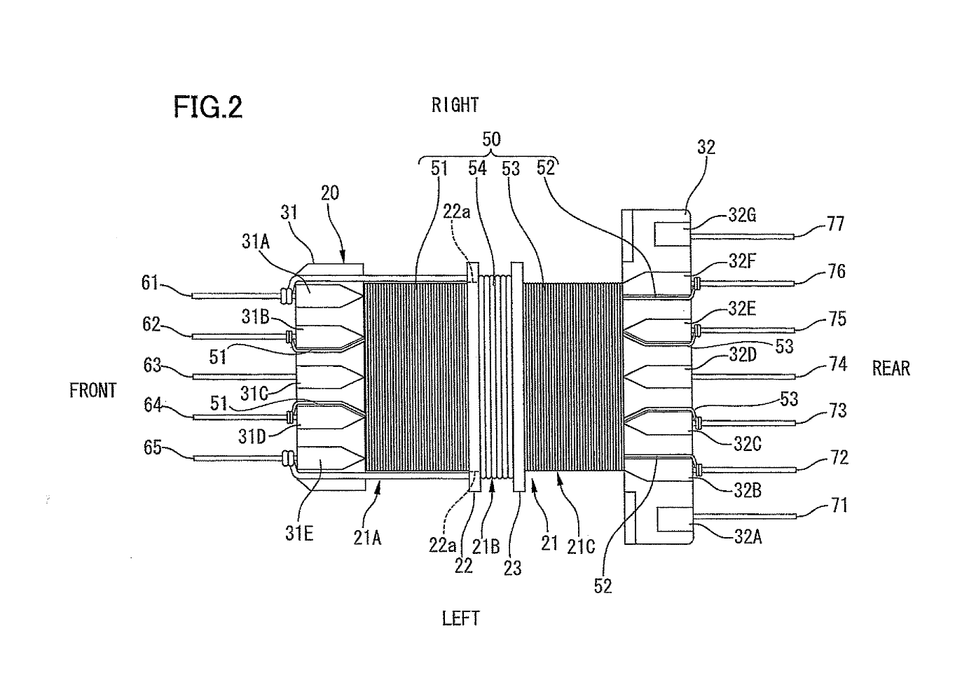

As shown in FIG. 2, the bobbin 20 includes a tubular portion 21 and terminal bases 31, 32, each provided at each axial end portion of the tubular portion 21. The bobbin 20 is made from an electrically insulating resin. The surrounding portion 10B surrounds the tubular portion 21.

The tubular portion 21 has a rectangular cross-section taken along an imaginary plane perpendicular to an axis of the tubular portion 21. The rectangular shape includes a pair of linear sides extending parallel to each other, and a pair of linear top side 21E and linear bottom side 21D extending parallel to each other. Each central stem portion 10C of each core 10 is inserted into a hollow space of the tubular portion 21. The tubular portion 21 has an axial length of approximately 33 mm. The bottom side 21D of the tubular portion 21 extends in a direction parallel to a surface of the circuit board (not shown) when the transformer 1 is surface-mounted thereon. The bottom side corresponds to a circuit board confronting portion.

Two partitioning plates 22, 23 protrude outward from an outer peripheral surface of the tubular portion 21 in the imaginary plane and extend along an entire circumferential length thereof. The partitioning plates 22, 23 are spaced away from each other in the axial direction of the tubular portion 21 to define a first section 21A, a second section 21B, and a third section 21C.

A length of each partitioning plate 22, 23 from its upper edge to its lower edge is approximately 10 mm, and a distance between the partitioning plates 22 and 23 in the axial direction is approximately 4 mm.

The partitioning plate 22 has right end portion and left end portion each formed with a groove 22a extending in the axial direction (extending along the thickness of the partitioning plate 22, 23) so as to communicate the first section 21A with the second section 21B.

Each of the terminal bases 31, 32 is provided integrally with each axial end portion of each bottom side of the tubular portion 21. Each of the terminal base 31, 32 extends in a direction perpendicular to the axial direction of the tubular portion 21.

The terminal base 31 has five terminal electrodes 61, 62, 63, 64, 65 arrayed in the extending direction of the terminal base 31 with a predetermined interval. The terminal electrodes 61-65 is in the form of metallic pin protruding in the axial direction of the tubular portion 21 and away from the other terminal base 32.

The other terminal base 32 has seven terminal electrodes 71, 72, 73, 74, 75, 76, 77 arrayed in the extending direction of the terminal base 32 with a predetermined interval. The terminal electrodes 71-77 are in the form of metallic pin protruding in the axial direction of the tubular portion 21 and away from the terminal base 31. The terminal base 31 has a bottom surface provided with five protrusions 31A, 31B, 31C, 31D, 31E protruding downward and extending in the axial direction of the tubular portion 21. The other terminal base 32 has a bottom surface provided with seven protrusions 32A, 32B, 32C, 32D, 32E, 32F, 32G protruding downward and extending in the axial direction.

The conductive wire 50 includes a first primary winding 51, a second primary winding 54, a first secondary winding 52, and a second secondary winding 53. Each of the first primary winding 51 and the first and second secondary windings 52, 53 includes a copper wire coated with an electrically insulation coating made from urethane. The second primary winding 54 includes a copper wire and has a trilaminar insulation coating structure whose insulation properties is higher than that of the insulation coating of the first primary winding 51 and the first and second secondary windings 52, 53.

The first primary winding 51 is wound over the first section 21A so as to be wound within a profile of the partitioning plates 22, 23 as viewed in the axial direction. Each end portion of the first primary winding 51 is drawn toward the terminal base 31, and one end portion passes between the protrusions 31B and 31C, and other end portion passes between the protrusions 31C and 31D. The end portions are wound over the terminal electrodes 62, 64, respectively, and are then electrically connected thereto by soldering. Incidentally, FIG. 2 shows a state, for the purpose of simplicity, where the end portions are just wounded over the terminal electrodes 62, 64 prior to soldering. Similarly, in FIG. 2, the state prior to soldering is shown with respect to the first secondary winding 52, second secondary winding 53 and second primary winding 54 for simplicity.

The first secondary winding 52 is wound over the third section 21C so as to be wound within the profile of the partitioning plates 22, 23 as viewed in the axial direction. Each end portion of the first secondary winding 52 is drawn toward the terminal base 32, and one end portion passes between the protrusions 32B and 32C, and other end portion passes between the protrusions 32E and 32F. The end portions are wound over the terminal electrodes 72, 76, respectively, and are then electrically connected thereto by soldering.

Similarly, the second secondary winding 53 is wound over the first secondary winding 52 already been wound over the third section 21C so as to be wound within the profile of the partitioning plates 22, 23 as viewed in the axial direction. Each end portion of the second secondary winding 53 is drawn toward the terminal base 32, and one end portion passes between the protrusions 32C and 32D, and other end portion passes between the protrusions 32D and 32E. The end portions are wound over the terminal electrodes 73, 75, respectively, and are then electrically connected thereto by soldering.

The second primary winding 54 is wound over the second section 21B so as to be wound within the profile of the partitioning plates 22, 23 as viewed in the axial direction. Each end portion of the second primary winding 54 passes through each groove 22a and is drawn toward the terminal base 31 while being in confrontation with the side surface of the tubular portion 21. One end portion extends along the right side of the protrusion 31A, and other end portion extends along the left side of the protrusion 31E. These end portions are wound over the terminals 61, 65, respectively and are then electrically connected thereto by soldering. The terminal electrode 61 is electrically connected to the terminal electrode 62 on the circuit board (not shown), so that the second primary winding 54 is connected in serried to the first primary winding 51 so as to constitute a primary winding along with the first primary winding 51. As shown in FIG. 1, electrically insulating tapes 81 are wound over the first primary winding 51, second primary winding 54, and second secondary winding 53, respectively, even though these tapes 81 are omitted in FIG. 2 for simplicity.

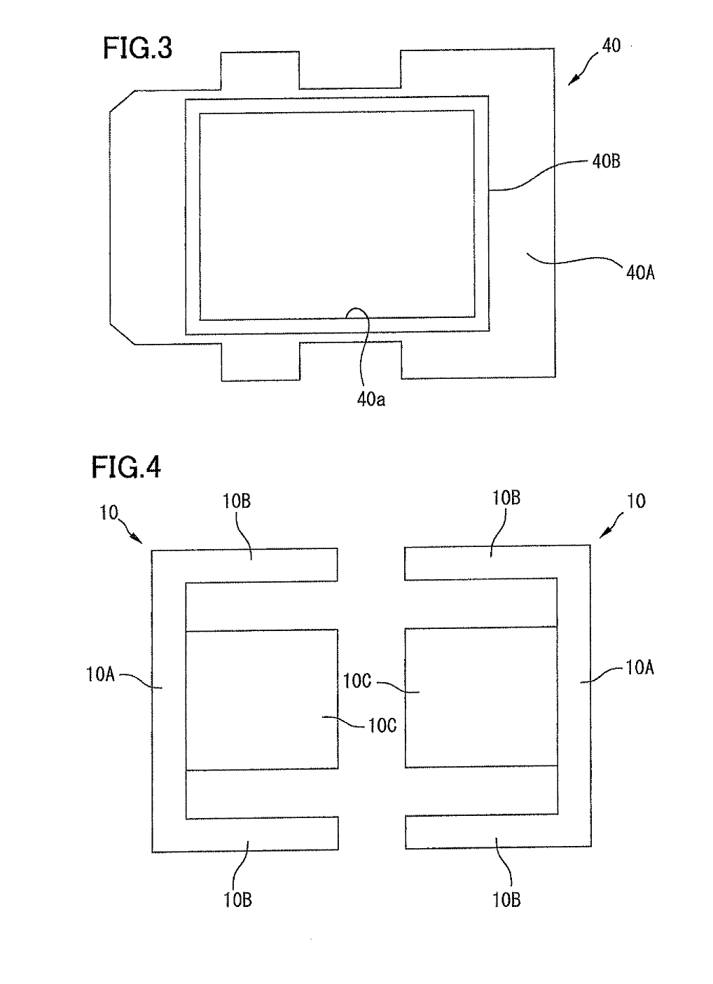

As shown in FIG. 3, the case 40 is of a generally rectangular plate like shape and is made from an electrically insulating resin. Each corner portion at one minor side is notched into rectangular shape, and each intermediate portion of each major side is also notched into rectangular shape. Further, a rectangular through-hole 40a whose major side extends in a longitudinal direction of the case 40 is formed at a center portion thereof. The through-hole 40a is adapted to allow the tubular portion 21 to protrude therethrough. Each central stem portion 10C of each core 10 is inserted into the hollow space of the tubular portion 21 while the tubular portion 21 is inserted into the through-hole 40a for assembling the transformer 1.

A wall portion extending along and protrudes from each major side of the through-hole 40a upward from an upper surface 40A of the case 40. A flange 4013 extending in a direction parallel to the upper surface 40A is provided at protruding ends of the wall portions. The flange 40B is provided along an entire perimeter of the through-hole 40a.

In the transformer according to the above-described embodiment, the outer peripheral surface of the tubular portion 21 is divided into three sections 21A, 21B and 21C, and first primary winding 51 is wound over the first section 21A, the first secondary winding 52 and the second secondary winding 53 are wound over the third section 21C, whereas the second primary winding 54 provided with trilaminar insulation structure is wound over the second section 21B. Therefore, a dead space conventionally required for spacing away the primary winding from the secondary winding can be effectively used for winding the second primary winding 54. Consequently, resultant transformer 1 can be downsized and can provide a low-profile, while providing the primary and secondary winding with a desired numbers of turns.

Further, enhanced magnetic coupling between the primary and secondary windings can be obtained, since the second primary winding 54 functioning as a part of the primary winding is wound over the second section 21B, thereby reducing leakage inductance to meet with the demand of higher frequency. Further, a level of the leakage inductance can be controlled by controlling the numbers of turns of the second primary winding 54. That is, increasing the numbers of turns can reduce the level of the leakage inductance, and decreasing the numbers of turns can increase the level of the leakage inductance.

Further, all primary winding or all secondary windings need not be a wire provided with trilaminar insulation coatings. Therefore, the transformer 1 can be produced at a low cost, since the trilaminar coating wire is generally expensive, and drawbacks of reducing the numbers of turns of the wires due to the increased diameter of the wire caused by increased thickness of the trilaminar insulation coating can be obviated.

Further, stabilized insulation can be obtained because of the employment of the wire provided with the trilaminar insulating coatings which is a highly insulating wire. Further, because of the formation of the partition plates 22, 23, the primary winding, the secondary winding, and the second primary winding 54 can be easily provided at the associated one of the sections.

Further, the partitioning plate 22, 23 is formed with the grooves 22a extending in the axial direction of the tubular portion 21 so that the one end portion and other end portion of the second primary winding 54 pass through the grooves 22a and are in confrontation with the side surface of the tubular portion 21 to extend in the axial direction. This structure can restrict the position of the end portions of the second primary winding 54 so as to avoid these end portions to extend upward or downward away from the bobbin 20. Consequently, low profile can be ensured in the transformer 1.

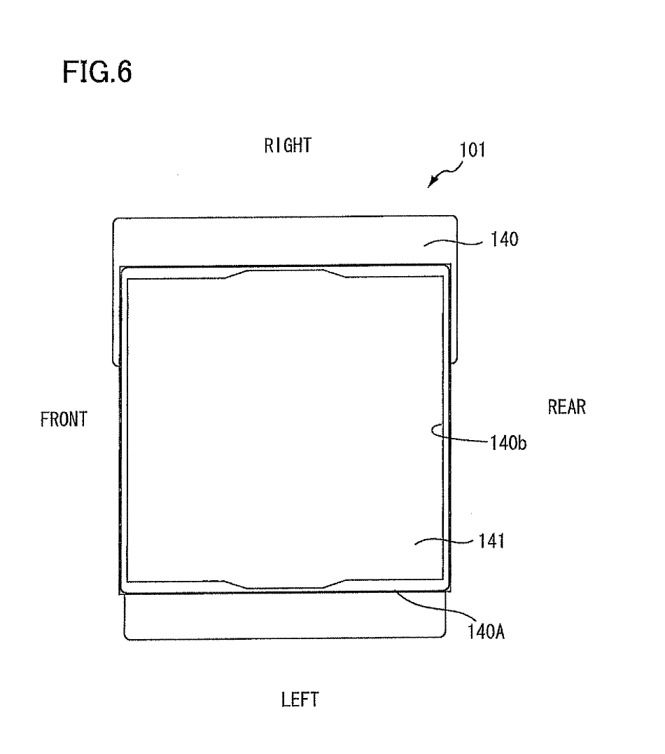

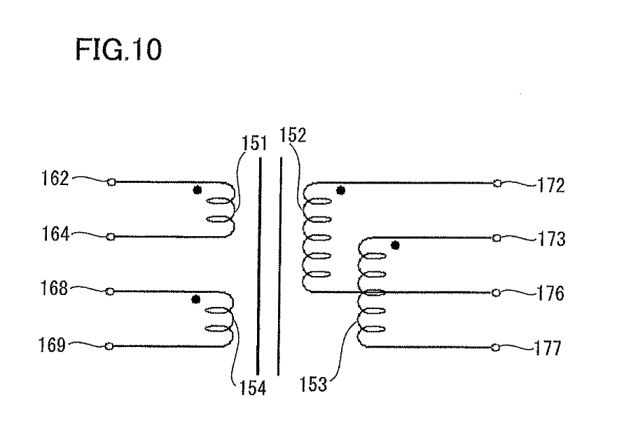

A transformer 101 according to a second embodiment of the present invention will next be described with reference to FIGS. 6 through 10. With reference to the second embodiment, an upper side and a lower side in FIG. 6 will be referred to as “rightward” and “leftward”, respectively, and a left side and right side in FIG. 6 will be referred to as “frontward” and “rearward”, respectively.

The transformer 101 includes a core 110, a bobbin 120, a case 140, and a conductive wire 150. The core 110 has a pair of end plate portions 110A, a pair of side plate portions 110B and a central stem portion 110C similar to end plate portions 10A, the side plate portions 10B, and the central stem portion 10C in the first embodiment.

The bobbin 120 includes a tubular portion 121 and terminal bases 131, 132, each provided at each axial end portion of the tubular portion 121. The bobbin 120 is made from an electrically insulating resin.

The tubular portion 121 has shape similar to that of the tubular portion 21. That is, the tubular portion 121 has a rectangular cross-section taken along an imaginary plane perpendicular to an axis of the tubular portion 121. The rectangular shape includes a pair of linear sides extending parallel to each other, and a pair of linear top side 121E and linear bottom side 121D extending parallel to each other. Each central stem portion 110C of each core 110 is inserted into a hollow space 121a of the tubular portion 121. The tubular portion 121 has an axial length of approximately 31 mm. The bottom side 121D of the tubular portion 21 extends in a direction parallel to a surface of the circuit board (not shown) when the transformer 101 is surface-mounted thereon. The bottom side 121D corresponds to a circuit board confronting portion.

Two partitioning plates 122, 123 protrude outward from an outer peripheral surface of the tubular portion 121 in the imaginary plane and extend along an entire circumferential length thereof. The partitioning plates 122, 123 are spaced away from each other in the axial direction of the tubular portion 21 to define a first section 121A, a second section 121B, and a third section 121C. However, a distance between the partitioning plates 122 and 123 is smaller than that of a distance between the partitioning plates 22 and 23 in the first embodiment, so that a groove (annular groove) is provided by the partitioning plates 122, 123 and the second section 121B. Thus, the second section 121B is of groove-like fashion.

A length of each partitioning plate 122, 123 from its upper edge to its lower edge is approximately 15 mm, and a distance between the partitioning plates 122 and 123 in the axial direction must be greater than 1 mm, for example, 1.2 mm.

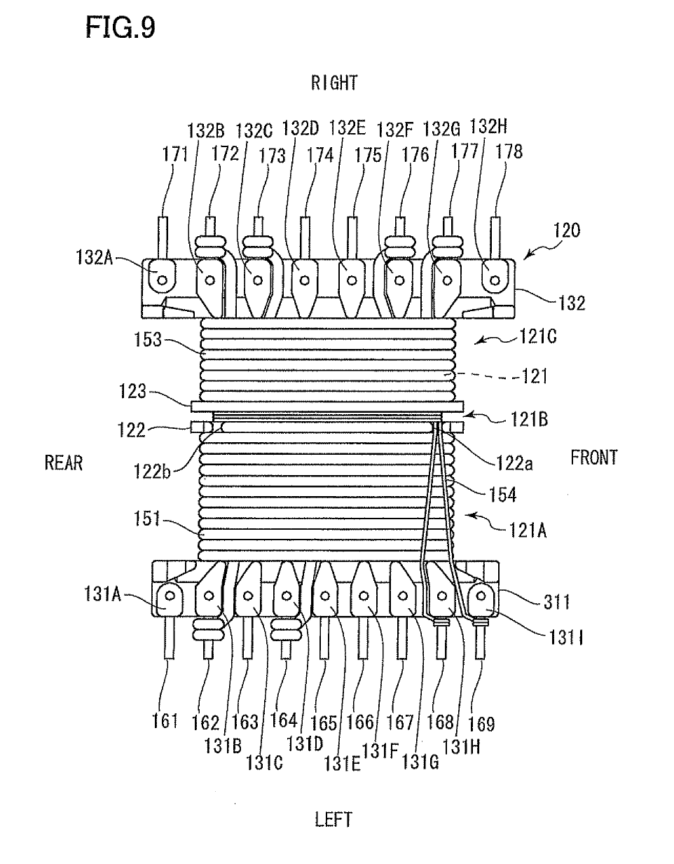

As shown in FIG. 9, a part of the partitioning plate 122 provided at the bottom side 121D is formed with a pair of grooves 122a, 122b positioned at front and rear end portions of the partitioning plate 122, respectively. These grooves 122a, 122b extend in the axial direction (extending along the thickness of the partitioning plate 122) so as to communicate the first section 121A with the second section 121B.

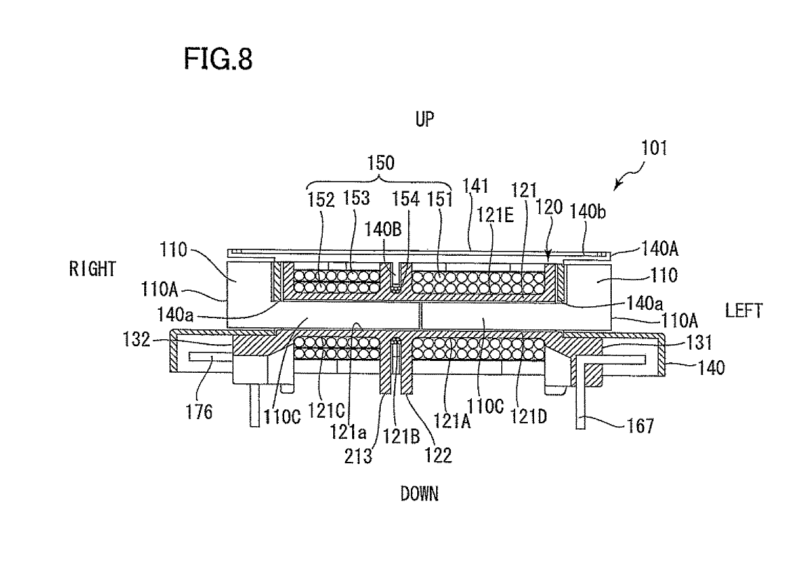

Each of the terminal bases 131, 132 is provided integrally with each axial end portion of each bottom side 121D of the tubular portion 121. Each of the terminal base 31, 32 extends in a direction perpendicular to the axial direction of the tubular portion 121. The terminal base 131 has nine terminal electrodes 161, 162, 163, 164, 165, 166, 167, 168, 169 arrayed in the extending direction of the terminal base 131 with a predetermined interval. These terminal electrodes 161-169 are in the form of metallic L-shaped pins (FIG. 8) each having one arm protruding from the terminal base 131 in the axial direction of the tubular portion 121 and away from the other terminal base 132, and another arm protruding downward from the terminal base 131.

The other terminal base 132 has eight terminal electrodes 171, 172, 173, 174, 175, 176, 177, 178 arrayed in the extending direction of the terminal base 132 with a predetermined interval. These terminal electrodes 171-178 are in the form of metallic L-shaped pins each having one arm protruding from the terminal base 132 in the axial direction of the tubular portion 121 and away from the terminal base 131, and another arm protruding downward from the terminal base 132. The terminal base 131 has a bottom surface provided with nine protrusions 131A, 131B, 131C, 131D, 131E, 131F, 131G, 131H, 131I protruding downward and extending in the axial direction of the tubular portion 121. The other terminal base 132 has a bottom surface provided with eight protrusions 132A, 132B, 132C, 132D, 132E, 132F, 132G, 132H protruding downward and extending in the axial direction.

As shown in FIG. 8, the conductive wire 150 includes a primary winding 151, an auxiliary winding 154, a first secondary winding 152, and a second secondary winding 153. Each of the primary winding 151 and the first and second secondary windings 152, 153 includes a copper wire coated with an electrically insulation coating made from urethane. The auxiliary winding 154 includes a copper wire and has a trilaminar insulation coating structure whose insulation properties is higher than that of the insulation coating of the primary winding 151 and the first and second secondary windings 152, 153 available for safety standard IEC 60065 and the like.

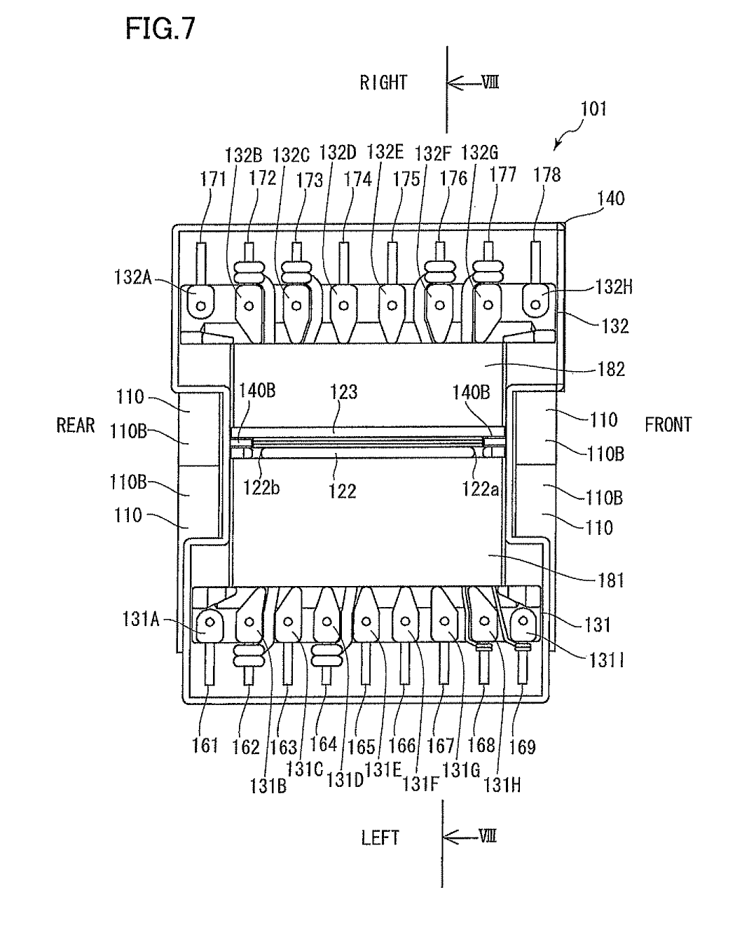

The primary winding 151 is wound over the first section 121A so as to be wound within a profile of the partitioning plates 122, 123 as viewed in the axial direction. Each end portion of the first primary winding 151 is drawn toward the terminal base 131, and one end portion passes between the protrusions 131B and 131C, and other end portion passes between the protrusions 131D and 131E. The end portions are wound over the terminal electrodes 162, 164, respectively, and are then electrically connected thereto by soldering. Incidentally, FIGS. 7 and 9 shows a state, for the purpose of simplicity, where the end portions are just wounded over the terminal electrodes 162, 164 prior to soldering. Similarly, in FIGS. 7 and 9, the state prior to soldering is shown with respect to the first secondary winding 152, second secondary winding 153 and auxiliary winding 154 for simplicity.

The first secondary winding 152 is wound over the third section 121C so as to be wound within the profile of the partitioning plates 122, 123 as viewed in the axial direction. Each end portion of the first secondary winding 152 is drawn toward the terminal base 132, and one end portion passes between the protrusions 132B and 132C, and other end portion passes between the protrusions 132E and 132F. The end portions are wound over the terminal electrodes 172, 176, respectively, and are then electrically connected thereto by soldering.

Similarly, the second secondary winding 153 is wound over the first secondary winding 152 already been wound over the third section 121C so as to be wound within the profile of the partitioning plates 122, 123 as viewed in the axial direction. Each end portion of the second secondary winding 153 is drawn toward the terminal base 132, and one end portion passes between the protrusions 132C and 132D, and other end portion passes between the protrusions 132F and 132G. The end portions are wound over the terminal electrodes 173, 177, respectively, and are then electrically connected thereto by soldering.

The auxiliary winding 154 is wound over the second section 121B so as to be wound within the profile of the partitioning plates 122, 123 as viewed in the axial direction. Each end portion of the auxiliary winding 154 passes through one of the grooves 22a and is drawn toward the terminal base 131 while being in confrontation with the bottom surface 121D of the tubular portion 121 at a position close to the front end portion thereof. One end portion of the auxiliary winding 154 passes between the protrusions 131G and 131H, and another end portion thereof passes between the protrusions 131H and 131I. These end portions are wound over the terminals 168, and 169, respectively, and are then electrically connected thereto by soldering.

An IC (not shown) is provided on the circuit board (not shown) for drivingly controlling the transformer 101, and the auxiliary winding 154 is electrically connected to the IC on the circuit board for supplying a source voltage to the IC. With this arrangement, the source voltage can be applied to the IC by way of the auxiliary winding 154, and therefore, an additional transformer for supplying source voltage to the IC can be dispensed with, thereby enabling cost reduction.

As shown in FIG. 7, electrically insulating tapes 181, 182 are wound over the primary winding 151, and the second primary winding 153 at the first section 121A and the third section 121C, respectively, even though these tapes are omitted in FIG. 9 for simplicity. The insulating tape 181 also covers the drawn out portion of the auxiliary winding 154 spanning from the groove 122a toward the terminal base 131.

The case 140 is made from an electrically insulating resin. As shown in FIGS. 6 through 8, the case 140 covers an entire upper side, left side, right side, front side and rear side of the bobbin 120. The case 140 is formed with a pair of through-holes 140a (FIG. 8) each being positions in alignment with each open end of the internal space 121a of the tubular portion 121. Size and shape of each through-hole 140a is identical to those of the open end of the internal space 121a. Thus, the central stem portions 110C of the core 110 extends through the through-hole 140a and into the internal space 121a. With this structure, direct confrontation of the core 110 with any one of the primary winding 151, the auxiliary winding 154, the first secondary winding 152 and the second secondary winding 153 can be avoided, but one of the case 140 and the bobbin 120 can be interposed between the core 110 and any one of the primary winding 151, the auxiliary winding 154, the first secondary winding 152 and the second secondary winding 153. The interposed region of the case 140 will be referred to as a main body portion of the case.

As shown in FIG. 6, the uppermost portion of the case 140 includes a generally rectangular shaped plate portion 140A whose uppermost surface is formed with a recessed portion 140b. The recessed portion 140b occupies almost entire uppermost surface of the rectangular shaped plate 140A except its contour (edge line). Further, a generally rectangular metal plate 141 is provided in the recessed portion 140b. The metal plate 141 shields flux leakage generated from the conductive wire 150 upon application of electricity to the conductive wire 150 after the transformer 101 is surface-mounted on the circuit board. Accordingly, even if another metal plate is disposed at a position in confrontation with the transformer 101, inadvertent heating to the neighboring metal plate can be avoided.

As shown in FIGS. 7 and 8, the rectangular shaped plate portion 140A has a lower surface from which plate like ribs 140B protrude downward at a position in confrontation with the second section 121B. The plate like ribs 140B protrude in a direction perpendicular to the axial direction of the tubular portion 121. Each plate like rib 140B is located in confrontation with the top wall 132E and the side wall of the tubular portion 121, and is inserted into or engaged with the annular groove defined between the partitioning plates 122 and 123. The plate like rib 140B corresponds to a convex portion.

Because of the provision of the ribs 140B, a creepage distance between the primary winding 151 and the first secondary winding 152 and between the primary winding 151 and the second secondary winding 153 can be increased. Consequently, a distance in the axial direction of the tubular portion 121 between the primary winding 151 and the first secondary winding 152 and between the primary winding 151 and the second secondary winding 153 can reduced. Further, the case 140 can have a simplified structure because of integral structure of the rib 140B with the main body portion of the case 140.

Further, the transformer 101 includes the primary winding 151 having the insulation coating and wound over the first section 121A and electrically connected to the terminal electrodes 162, 164, the first and second secondary windings 152, 153 having the insulation coating and wound over the third section 121C and electrically connected to the terminal electrodes 172, 173, 176, 177, and the auxiliary winding 154 having the insulation coating whose insulating property is higher than that of the insulation coating of the windings 151, 152, 153 and wound over the second section 121B. Therefore, a conventional dead space between the primary winding and the secondary winding can be effectively utilized as a space for winding the auxiliary winding 154. Consequently, resultant transformer 101 can be downsized and can provide a low-profile, while providing the primary and secondary winding with a desired numbers of turns. Further, since the auxiliary winding 154 has trilaminar insulation coatings, a distance between the primary winding and the secondary winding in the axial direction of the tubular portion 121 can further be reduced.

Further, upon surface-mounting the transformer 101 onto the circuit board, the primary winding 151, the first secondary winding 152, the second secondary winding 153 and the auxiliary winding 154 are positioned spaced away from the circuit board by a predetermined distance, and the drawn out part of the auxiliary winding 154 from the second section 12113 to the terminal electrodes 168, 169 is in confrontation with the circuit board confronting portion of the primary winding 151. Therefore, a space between the primary winding 151 and the circuit board can be effectively utilized for the layout space of the drawn out part of the auxiliary winding 154.

Further, because of the parallel wall structure of the tubular portion 121, i.e., the top wall 121E and bottom wall 121D extending in parallel to each other, and the pair of side walls extending in parallel to each other, the windings 151 through 154 may be circularly wound while being in contact with the four corner portions of the tubular portion 121. Here, because the groove 122a is located near the corner portion of the tubular portion 121, the drawn out position of the auxiliary winding 154 from the second section 121B can be positioned as close as possible to the outer peripheral surface of the tubular portion 121. Consequently, the drawn out portion can be positioned sufficiently spaced away from the circuit board.

Various modifications are conceivable. For example, in the above-described embodiments, instead of the trilaminar insulation coated wire, a wire coated with a material having an insulation property higher than that of the insulation coating of the primary winding and secondary winding can be used. Alternatively, the specific wire at the second section 21B. 121B can have a coating material whose insulation property is equal to that of the primary and secondary windings, but a coating thickness of the specific wire is greater than that of the primary and secondary windings.

Further, the positions of the terminal bases 31, 32, 131, 132 are not limited to the axially end portions of the tubular portion 21, 121, and accordingly, the positions of the terminal electrodes are not limited to the axially end portions.

Further, in the above-described embodiments, a single copper wire is used as the conductive wire of the first and second primary windings, and first and second secondary windings. However, a stranded copper wire is also available.

Further, in the above-described embodiments, the tubular portion 21 121 has the rectangular cross-section including top wall 21E, 121E, bottom wall 21D, 121D, and the pair of side walls. However, a cross-sectional shape other than rectangular shape such as a circular cross-section is also available.

Further, in the above-described embodiments, three sections 21A, 21B, 21C or 121A, 121B, 121C are provided. However, the numbers of the sections is not limited to three sections. For example, a plurality of sections can be provided for the primary windings, and a plurality of sections can be provided for the secondary windings. In these cases, an intermediary section is provided between the primary winding section and the secondary winding section for winding one of the additional primary and secondary windings or the auxiliary winding made from the wire having higher insulating performance.

Further, in the first embodiment, the trilaminar insulation coated wire wound over the second section 21B functions as a part of the primary winding. However, the trilaminar insulation coated wire can be a part of the secondary winding.

Further, in the first embodiment, the second primary winding 54 is connected in series to the first primary winding 51. Instead, the second primary winding 54 is connected in parallel to the first primary winding 51.

Further, in the second embodiment, the case 140 includes the main body portion and the plate like ribs 140B integrally therewith. However, a case other than the case 140 can be used.

Further, in the second embodiment, the auxiliary winding 154 is electrically connected to the IC that drivingly controls the transformer 101 in order to supply electric power to the IC. However, electrical connection of the auxiliary winding 154 is not limited to this fashion.

While the invention has been described in detail with reference to the specific embodiments thereof, it would be apparent to those skilled in the art that various changes and modifications may be made therein without departing from the scope of the invention.

What is claimed is:

1. A transformer comprising:
a bobbin made from an electrically insulating material and having a tubular portion defining an axial direction and an internal space, the tubular portion having an outer peripheral surface providing a first section, a second section, and a third section arrayed side by side in the axial direction;
a plurality of terminal electrodes provided at the bobbin and including a first terminal electrode, a second terminal electrode, a third terminal electrode, a fourth terminal electrode, a fifth terminal electrode, and a sixth terminal electrode;
a core inserted into the internal space;
a primary winding of a conductive wire coated with an insulating layer and wound over the first section, the primary winding having one end portion electrically connected to the first terminal electrode and another end portion electrically connected to the second terminal electrode;
a secondary winding of a conductive wire coated with an insulating layer and wound over the third section, the secondary winding having one end portion electrically connected to the third terminal electrode and another end portion electrically connected to the fourth terminal electrode;
an additional winding of a conductive wire coated with an insulation layer whose insulating performance is greater than that of the insulation layer of the primary winding and the secondary winding, the additional winding being wound over the second section, the additional winding having one end portion electrically connected to the fifth terminal electrode and another end portion electrically connected to the sixth terminal electrode.

2. The transformer as claimed in claim 1, wherein the additional winding constitutes one of additional primary winding and additional secondary winding.

3. The transformer as claimed in claim 2, wherein the insulation layer of the additional winding comprises a trilaminar insulation coating.

4. The transformer as claimed in claim 2, wherein the first section and a second section define a first boundary portion therebetween, and the second section and the third section define a second boundary portion therebetween; and
wherein the tubular portion includes a first partition plate positioned at the first boundary portion and protruding outward from the outer peripheral surface and extending along an entire outer peripheral surface, and a second partition plate positioned at the second boundary portion and protruding outward from the outer peripheral surface and extending along the entire outer peripheral surface.

5. The transformer as claimed in claim 4, wherein the tubular portion has a rectangular cross-section including a pair of side wall portions extending parallel to each other in the axial direction, a top wall portion and a bottom wall portion; and,
wherein the plurality of terminal electrodes are provided at an axially end portion of the tubular portion; and,
wherein one of the first partition plate and the second partition plate is formed with a pair of grooves extending in the axial direction at positions on the side wall portions, the one end portion of the additional winding passing through one of the pair of grooves to extend in the axial direction along the one of the side walls, and another end portion of the additional winding passing through remaining one of the pair of grooves to extend in the axial direction along the remaining one of the side walls.

6. The transformer as claimed in claim 1, wherein the core has an insertion portion inserted into the internal space and a surrounding portion surrounding the tubular portion.

7. The transformer as claimed in claim 6, wherein the first section and a second section define a first boundary portion therebetween, and the second section and the third section define a second boundary portion therebetween; and
wherein the tubular portion includes a first partition plate positioned at the first boundary portion and protruding outward from the outer peripheral surface and extending along an entire outer peripheral surface, and a second partition plate positioned at the second boundary portion and protruding outward from the outer peripheral surface and extending along the entire outer peripheral surface, a combination of the first partition plate and the second partition plate defining a groove like second section; and,
the transformer further comprising a case comprising a main body portion interposed between the core and each one of the primary winding, the secondary winding, and the additional winding, and a convex portion inserted into the groove like second section.

8. The transformer as claimed in claim 7, wherein the main body portion and the convex portion are integral with each other.

9. The transformer as claimed in claim 7, wherein the tubular portion has a circuit board confronting portion confronting a circuit board when the transformer is surface-mounted thereon; and,
wherein the tubular portion has end portions in the axial direction at which the plurality of terminal electrodes are provided; and
wherein the additional winding has a drawn-out portion drawn out from the second section and directing toward the fifth electrode and the sixth electrode, the drawn-out portion being positioned in confrontation with the circuit board confronting portion.

10. The transformer as claimed in claim 9, the tubular portion has a rectangular cross-section having a top wall portion, a bottom wall portion as the circuit board confronting portion, and a pair of side wall portions, thus defining corners at intersections between the bottom wall portion and the pair of side wall portions, the additional winding being drawn out from the second section at a position close to one of the corners, whereby the drawn-out portion extends along the one of the corners.

11. The transformer as claimed in claim 10, wherein one of the first partition plate and the second partition plate is formed with a groove at a position on the bottom wall portion and close to the one of the corners to allow the drawn-out portion to pass therethrough to thus define a drawn-out position of the additional winding.

12. The transformer as claimed in claim 6, wherein the insulation layer of the additional winding comprises a trilaminar insulation coating.

13. The transformer as claimed in claim 1, wherein the insulation layer of the primary winding, the insulation layer of the secondary winding, and the insulation layer of the additional winding are made of a material identical to one another, and the insulation layer of the additional winding has a thickness greater than that of the insulation layer of the primary winding and the insulation layer of the secondary winding.
